(19) United States
(12) Patent Application Publication
(10) Pub. No.: US 2026/0189362 A1
(43) Pub. Date: Jul. 2, 2026

(54) FULLY HOMOMORPHIC ENCRYPTION (FHE) ACCELERATOR PERMUTATION APPLICATION INTEGRATED CIRCUIT

(71) Applicant: Chain Reaction, Ltd., Tel Aviv (IL)

(72) Inventors: Ilan ROSENFELD, Petah Tikva (IL); Noam KLEINBURD, Hashmonaim (IL); Oren VRUBEL, Tel Aviv (IL)

(73) Assignee: Chain Reaction, Ltd., Tel Aviv (IL)

(21) Appl. No.: 19/002,302

(22) Filed: Dec. 26, 2024

(51) Int. Cl. H04L 9/00

(52) U.S. Cl. CPC H04L 9/008

(57) ABSTRACT

A method and system of the device may include a plurality of permute units, where each of the plurality of permute units is configured to perform local permutations on polynomial coefficients of an FHE program executed by the FHE accelerator; where the plurality of permute units are controlled by a set of permute operations, and where the permute operations are derived from instructions complied to minimize dataflows of coefficients in the FHE accelerator while utilizing variable resources of the permutation module and an internal fabric for different permutations.

The subject matter of the present application relates to U.S. patent application Ser. No. 18/809,976 filed on Aug. 20, 2024, the contents of which are hereby incorporated by reference in their entirety for all purposes.

### TECHNICAL FIELD

The present disclosure generally relates to fully homomorphic encryption (FHE) schemes and, more specifically, to integrated circuitry for permutation applications in FHE accelerators.

### BACKGROUND

FHE enables computations on encrypted data without the need to decrypt it first. The Cheon-Kim-Kim-Song (CKKS) scheme is one of the encryption methods used in FHE, particularly well-suited for arithmetic on complex numbers. A core feature of FHE is the ability to perform computations on encrypted data. With CKKS, one can perform addition, subtraction, and multiplication on ciphertexts, which correspond to similar operations on the original plaintext numbers. To increase efficiency, a sequence of values can be encrypted into a single ciphertext, and this sequence can be rotated. Importantly, CKKS allows these operations to be performed with low noise growth, which is a significant challenge in FHE. As operations are performed on ciphertexts, noise accumulates within the encrypted data. If the noise grows too large, it can lead to incorrect decrypted results. CKKS mitigates this noise by scaling down ciphertexts after multiplications.

The CKKS scheme includes a noise control technique called Rescaling, which also reduces the size of the ciphertext. When the size of a ciphertext reaches a certain threshold, the bootstrapping process (BTS) can be applied. Bootstrapping refreshes the ciphertext, increasing its size and enabling further computations. This process is crucial, allowing FHE schemes to practically perform an unlimited number of homomorphic computations on encrypted data.

The bootstrapping process typically involves three major steps: starting with the Coefficients-to-Slots (C2S) step, followed by the polynomial evaluation (Sine) step, and concluding with the Slots-to-Coefficients (S2C) step. In an FHE scheme, an encrypted message is presented as a polynomial. The C2S step homomorphically evaluates the inverse discrete Fourier transform (IDFT) and produces a ciphertext that can be evaluated. The Sine step implements homomorphic modular reduction on the ciphertext. The modular reduction is approximated by a sinusoidal (Sine) function, which scales down the message and produces a remainder polynomial of the modular operation (typically modulo 1). Then, the message is scaled back. The scheme parameters determine the range and degree of the approximation, with the Sine step accounting for the secret-key density. Finally, the S2C step homomorphically evaluates the DFT on the ciphertext to revert to an approximation of the original encrypted message.

The bootstrapping process is a crucial part of any application performing FHE operations. It is executed to ensure that noise resulting from operations does not grow too large, which could lead to incorrect decrypted results. The frequency of executing the bootstrapping process is determined by the application programmer and must be frequent enough to maintain the accuracy of the decrypted results.

The bootstrapping process is complex and requires a significant amount of computational and memory resources. Additionally, executing FHE programs involves extensive intra-chip data movement. This data movement results from polynomial computations, particularly permutations at the polynomial level, performed during bootstrapping or other FHE program executions.

The movement of data within the chip requires extremely high bandwidth and increases the power consumption of the processor (chip) running the FHE program. For instance, in a typical configuration, the bandwidth would be five hundred Tb/sec for a chip operating at a 1 GHz clock speed, with a total power consumption of 200 watts. The bandwidth and power consumption needed specifically for permutation dataflow alone are impractical.

To effectively implement FHE in real-time commercial applications, it is essential to minimize internal dataflows to prevent them from becoming a bottleneck. Overcoming this bottleneck would increase computational resource utilization and reduce power consumption.

Therefore, it would be advantageous to provide a solution that addresses the challenges mentioned above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, the permutation module may include a plurality of permute units, where each of the plurality of permute units is configured to perform local permutations on polynomial coefficients of an FHE program executed by the FHE accelerator; where the plurality of permute units are controlled by a set of permute operations, and where the permute operations are derived from instructions complied compiled to minimize dataflows of coefficients in the FHE accelerator while utilizing variable resources of the permutation module and an internal fabric for different permutations. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows a functional block diagram of a server, in accordance with some of the disclosed embodiments;

FIG. 2 shows a block diagram of a permutation module of the FHE accelerator, in accordance with some of the disclosed embodiments;

FIG. 3A shows a block diagram of a permutation unit based on a single toggle circuit, in accordance with some of the disclosed embodiments;

FIG. 3B shows a block diagram of another permutation unit based on a plurality of toggle circuits, in accordance with some of the disclosed embodiments;

FIG. 4 shows a block diagram of, yet another permutation, in accordance with some of the disclosed embodiments;

FIG. 5 shows a block diagram of, yet another permutation unit, in accordance with some of the disclosed embodiments; and

FIG. 6 shows a block diagram of yet another permutation unit, in accordance with some of the disclosed embodiments.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The objective of the present disclosure is to provide a Fully Homomorphic Encryption (FHE) Accelerator designed to manage massive data traffic, enabling the effective application of FHE in real-time commercial use. This design focuses on optimizing internal dataflow within the FHE accelerator to prevent bottlenecks, ensuring high utilization of computational resources, and reducing power consumption.

It should be noted that permutations on the polynomial level are a key operation for performing rotations and permutations on polynomials, particularly essential in FHE applications. These operations enable rotations of a vector ‘a’ by manipulating the polynomial encoding it. Although designed for efficiency within certain algorithms, such as those used in FHE, these operations are highly traffic-dependent, with rotations being critical to numerous computations. The rotations are conducted through polynomial transformations, making them computationally feasible in FHE settings, but they place a significant burden on data traffic management. Therefore, the objective of the present disclosure is to provide an FHE accelerator focused on optimizing internal dataflow to achieve high-efficiency utilization of permutation operations. In an embodiment, the FHE accelerator is realized as an application-specific integrated circuit (ASIC).

It will be appreciated that permutations on the polynomial level refer to applying permutations to polynomial coefficients, which represent vectors of complex numbers. These permutations essentially rearrange the order of the polynomial coefficients.

It will be understood that rotation is a particular type of permutation, where the elements of a vector are cyclically shifted by a specified amount. Specifically, a permutation rearranges the vector elements, while a rotation shifts them in a cyclic manner. This concept can be formalized as follows: Let mₐ(x) be the polynomial of order N, which encodes a vector a of complex numbers. The number of elements n in the vector is

$$n \leq \frac{N}{2} .$$

Let m_{R}_{ᵣ}(x) be the polynomial of order N, which represents the rotated vector Rᵣ=Rot(a, r), which is a version of the original vector a but shifted by r positions, where

$${R}_{r} [ k ] = a [ ( k + r ) mod \frac{N}{2} ] .$$

This defines how the rotation operates: for a given index k, the element in the rotated vector Rᵣ is taken from the original vector a, shifted by r positions, wrap-around behavior due to the modulo operation.

In cases of evaluation-mode representation assume Mₐ, M_{R}_{ᵣ} denote the evaluation-mode representation of the polynomials mₐ(x) and m_{R}_{ᵣ}(x), respectively. In evaluation-mode, polynomials are represented by their values at certain evaluation points, rather than by their standard coefficient form.

The following formula describes how the evaluation of the rotated polynomial M_{R}_{ᵣ} at index k is derived from the evaluation of the original polynomial

$${M}_{a} \cdot {M}_{{R}_{r}} [ k ] = {M}_{a} [ \frac{( {5}^{r} ( 2 \cdot k + 1 ) - 1 ) mod2 N}{2} ] .$$

The specific permutation involved is defined by 5^{r}(2·k+1) and the modulo operation determines the desired rotation in the polynomial's evaluation.

The disclosed subject matter is designed to address the challenge of data generation rates, which are determined by multiplying the data generated per permutation by the permutation rate. For example, at peak rates with a standard configuration of N=2¹⁶, while using a minimal key strategy, data generation can reach approximately 0.5 MB per clock cycle. For a 1 GHz clock, this results in 500 TB per second, implying bi-sectional data movement of around 250 TB per second.

The disclosed subject matter also reduces the power consumption, which is determined by multiplying data movement by the power cost per bit per distance. For example, assuming a square-shaped die with an average bit travel distance of 10 millimeters (mm) and an efficient transmission rate of 4e⁻¹⁴ J/bit/mm, the peak power consumed is calculated as: 500*8*10¹²*10*4e⁻¹⁴=1600 W. This results in extremely high and nearly impractical power consumption for managing the dataflow associated with permutations.

One technical improvement includes adjusting the parameters of C2S Matrix Decomposition, which influences required rotations and their associated statistics. Table 1 below shows the necessary rotations for different parameter choices of the C2S process performed as part of an FHE bootstrapping program. For example, the highest dataflow load may be for a rotation of 1. On the 2^{nd} row of Table 1, for example, the parameter choice is such that the rotation by 1 for

$${M}_{63}^{( 2 )}$$

is performed 15 times. Therefore, by minimizing the number of rotations by 1, the dataflow load, and hence bandwidth usage within the processor 371, can be reduced. This can be achieved by the optimal selection of BTS parameters matching an optimal ordering.

TABLE 1

| C2S Matrix Decomposition | (n₁, n₂) | Required Rotations |
|---|---|---|
| $ρ = 3 , {M}_{32}^{( 0 )} {M}_{63}^{( 1 )} {M}_{63}^{( 2 )}$ | (8,4), (8,8), (8,8) | 1024,8192, −32, −256, 1, 8 |
| $ρ = 3 , {M}_{32}^{( 0 )} {M}_{63}^{( 1 )} {M}_{63}^{( 2 )}$ | (8,4), (16,4), (16,4) | 1024,8192, −32, −512,1,16 |
| $ρ = 3 , {M}_{16}^{( 0 )} {M}_{63}^{( 1 )} {M}_{127}^{( 2 )}$ | (8,4), (8,8), (16,8) | 2048,8192, −64, −512,1,16 |
| $ρ = 4 , {M}_{16}^{( 0 )} {M}_{31}^{( 1 )} {M}_{31}^{( 2 )} {M}_{15}^{( 3 )}$ | (4,4), (8,4), (8,4), (4,4) | −2048, −8192, 128,1024, −8,−64,1,4 |

Another technical improvement for alleviating the burden of internal dataflow is optimizing the spatial order of coefficients, which has a significant impact on dataflow efficiency in systems that involve rotating data. The spatial order of coefficients represents specific data elements in a particular sequence, and their arrangement directly influences how efficiently data is moved during rotation operations. For instance, with N=64 coefficients, each index corresponds to a coefficient's position in the data array. In a “rotate by one” operation, all coefficients are shifted to pre-computed positions throughout the vector, and the efficiency of this movement is heavily influenced by the coefficient ordering.

Two ordering schemes highlight this effect: Naïve Ordering, where coefficients are arranged sequentially, and Even-Odd Ordering, where coefficients are alternately arranged into even and odd positions. The Even-Odd ordering can potentially reduce the distance data needs to travel, compared to the Naïve ordering, resulting in more efficient data movement. This optimization, referred to as the “dramatic effect” on dataflow, shows that the choice of coefficient ordering is crucial in minimizing data movement and enhancing system performance during rotation-heavy operations.

In some embodiments, optional orderings may include but are not limited to, Regular, Bit-Reverse, and Even-Odd orderings. The optional ordering may also include a permutation-specific order, which is mostly effective for a specific permutation of an example of rotation by one.

Yet another technical solution provided by the present disclosure is the exploitation of statistics from FHE program rotations and linear transformations, which are expressed as permutations in the polynomial domain. In some exemplary embodiments, dataflow can be significantly reduced by utilizing the present discloser's dedicated ASIC designed to leverage these statistics.

It should be noted that the FHE accelerator of the present disclosure is designed to execute FHE applications, and it is not limited to performing only permutations of coefficients, as discussed herein.

In another embodiment, the dedicated internal network is designed for efficient permutation data movement. By leveraging permutation statistics, this network supports dataflow locality, ensuring that the spatial order of coefficients is optimized for both performance and minimal data movement.

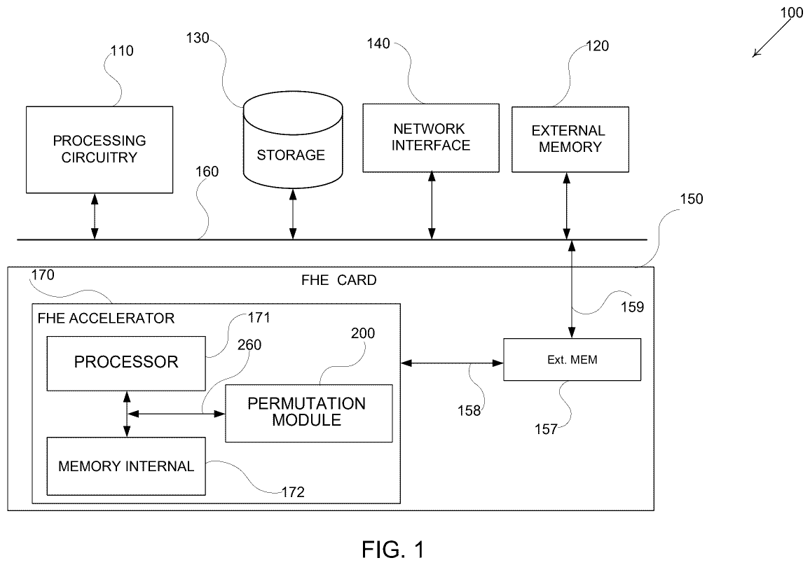

FIG. 1 shows a functional block diagram of server 100, in accordance with some of the disclosed embodiments. Server 100 includes a processing circuitry 110 coupled to a memory 120, a storage 130, a network interface 140, and an FHE card 150, which may be communicatively interconnected via a bus 160.

Processing circuitry 110 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

Memory 120 may be volatile (e.g., random access memory, etc.), non-volatile (e.g., read-only memory, flash memory, etc.), or a combination thereof. The storage 130 may include a non-volatile memory device, magnetic disk drive, optical disk drive, tape drive, and the like. Examples of memory 120 may include EEPROM, ROM, PROM, RAM, DRAM, SRAM, flash, firmware, programmable logic, and so on. Storage 130 may comprise an internal storage device, an attached storage device and/or a network-accessible storage device, and the like. Network interface 140 allows Server 100 to communicate with external systems. Network interface 140 can utilize various communication protocols.

Memory 120 and/or storage 130 may store software required to execute an FHE program or application, that is, a software program that requires the execution of an FHE scheme to perform one or more homomorphic operations. Bus 160 may include, for example, a PCIe bus.

The FHE program, according to the disclosed embodiment, is performed by FHE accelerator 170. It should be noted that the software shall be construed broadly to mean any type of instructions, whether referred to as software, firmware, middleware, microcode, hardware description language, or otherwise. Instructions may include code (e.g., in source code format, binary code format, executable code format, or any other suitable format of code).

The FHE card 150 is configured to rapidly perform complex encryption, decryption, and homomorphic operations. The FHE card 150 can be installed on Server 100 or operated as a standalone device. In some exemplary embodiments, FHE card 150 includes the FHE accelerator 170, which includes a processor 171, an internal memory 172, a permutation module (PM) 200, a network bus 240, and or several processors having internal memory designed for accelerating FHE scheme computational tasks.

In some exemplary embodiments, FHE accelerator 170, including all its subcomponents, may be implemented on a single ASIC die. It should be noted that the FHE accelerator 170 block, as depicted in the block diagram of FIG. 1, represents a functional block diagram, and should not be confused with the physical topology of the components or sub-components of FHE accelerator 170.

In some exemplary embodiments, processor 171 may include one or more cores designed to manage multiple computation threads simultaneously. Internal memory 172 may serve as dedicated memory for processor 171, storing data and instructions that cause processor 171 to execute the FHE program. PM 200 may be composed of a plurality of permute units designed to perform permutation operations, with a control bus 260 providing connectivity between the permute units of PM 200 and other components of FHE accelerator 170.

The data stored in internal memory 172 may include auxiliary data, evaluation keys, indeterminate data, or any combination thereof, or similar types of data. Internal memory 172 is designed for high bandwidth, enabling high-speed read/write cycles, thereby facilitating instant access for processor 171 to the data stored within.

Additionally, or alternatively, FHE accelerator 170 can be realized as an ASIC, an FPGA, an ASSP, a SoC, and any combination thereof, or any other hardware logic components that can perform calculations or other manipulations of information.

FHE card 150 also includes an external memory 157 and a memory bus 158. Memory bus 158 can have an interface through which the processor 171 communicates with the external memory 157. In some exemplary embodiments, external memory 157 can be realized as an SDRAM, high bandwidth SDRAM (e.g., GDDR5, GDDR6), or high bandwidth memory (HBM).

The FHE card 150 also includes Interface 159 designed as a communication interface with the bus 160. In some exemplary embodiments, bus 160, and hence Interface, may be realized as a PCIe.

It should be noted that the size of internal memory 172 is significantly smaller than the size of external memory 157. Internal memory 172 is considered “on-die” memory, and the data stored therein allows for the efficient execution of an FHE scheme, specifically a bootstrapping process for such a program. For example, the difference between the memory size of the external memory and the internal memory may be an order of magnitude. In current technologies, the size of internal memory 172 is limited to approximately 1 GB. Increasing the size of internal memory 172 would reduce the number of compute resources.

It will be remembered that the bootstrapping process is usually complex and requires a significant amount of computational and memory resources. Specifically, a typical FHE bootstrapping process (or simply bootstrapping) would require 10 GB of memory. This is in addition to the memory required to execute other parts of the FHE program. Currently, in existing solutions, data and auxiliary data used for bootstrapping are saved and repetitively loaded from memory 120 or external memory 157 to internal memory 172 during the execution of bootstrapping. In a typical program, bootstrapping occurs hundreds to thousands of times.

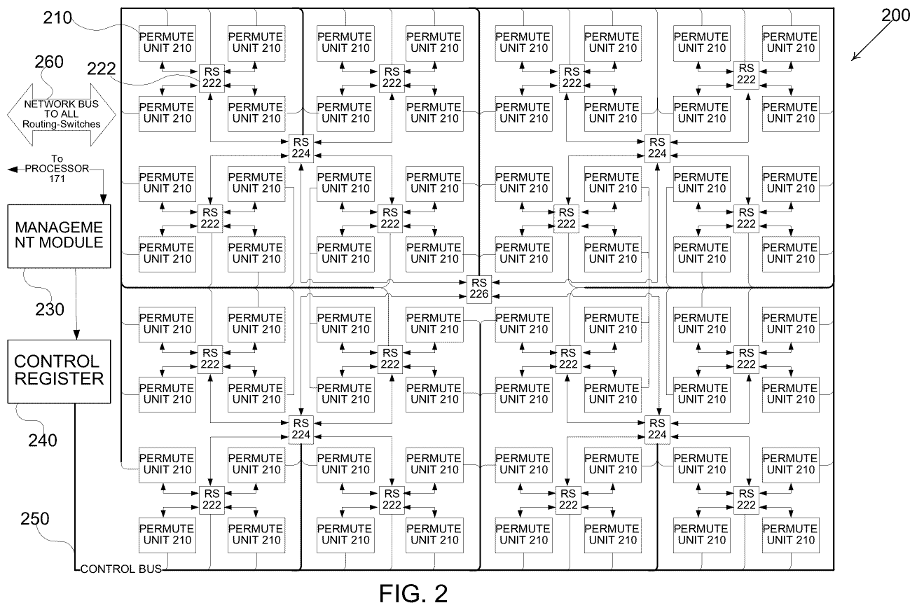

In some exemplary embodiments, processor 171 coupled with PM 200 (to be described in detail in FIG. 2) is designed to perform permutations and other polynomial operations while reducing the amount of internal data transfers. It should be emphasized that actual permutations of coefficients are performed by PM 200.

In some exemplary embodiments, FHE card 150 and its subcomponents may be configured to perform methods and techniques for improving internal performance used for FHE operations, such as described in the Ser. No. 18/809,976 application referenced above.

It should be understood that the embodiments described herein are not limited to the specific architecture illustrated in FIG. 1, and other architectures may be equally used without departing from the scope of the disclosed embodiments.

FIG. 2 shows a block diagram of a permutation module (PM) 200 of the FHE accelerator 170, in accordance with some of the disclosed embodiments.

PM 200 may be comprised of a plurality of permute unit 210, a management module 230, a control register (buffer) 240, a control bus 250, a control bus 260, and a plurality of routing switches (RS) 222, 224, and 226, which in some embodiments may be identical.

It should be appreciated that in a typical FHE scheme, polynomial operations are performed on 64K polynomial coefficients. In particular, the bootstrap process involves multiplication and rotations (permutations) during the Coefficients-to-Slots (C2S) and Slots-to-Coefficients (S2C) steps. The disclosed embodiments enable configuring the FHE accelerator 170 to minimize data transfers, enhancing the efficiency of these operations.

The permute module (PM) 200 of the FHE accelerator 170 (as shown in FIG. 1) includes a plurality of permute units 210, interconnected through routing switches (RS) 222, 224, and 226 in a topology based on a predefined hierarchy. In some exemplary embodiments, this topology connects sets of 4 permute units 210 via RS 222. Four RS 222 may be connected to each other through RS 224 to form a set of 16 permute units 210. Similarly, four RS 224 may be connected to each other through RS 226 to form a set of 64 permute units 210, thereby preserving the hierarchical structure.

Thus, it should be noted that in the exemplary embodiment of FIG. 2, each RS 222 is connected to 4 different permute units 210, each RS 224 is connected to 4 different RS 222, and each RS 226 is connected to 4 RS 224. Additionally, all RS 222, RS 224, and RS 226 are connected to the control bus 260, facilitating the dataflow and communication of coefficients between the plurality of permute units 210.

It should be emphasized that routing switches (RS) 222, 224, and 226 serve as gateways for interconnecting permute units 210 to one another and the network bus 260. In some exemplary embodiments, permute operations involving polynomial coefficients may need to be performed by permute units 210 (local permutation), by sets of 4 permute units 210 (adjacent permutation), by a set of 16 permute units 210 (distant permutation), or by a set of 64 permute units 210 (remote permutation).

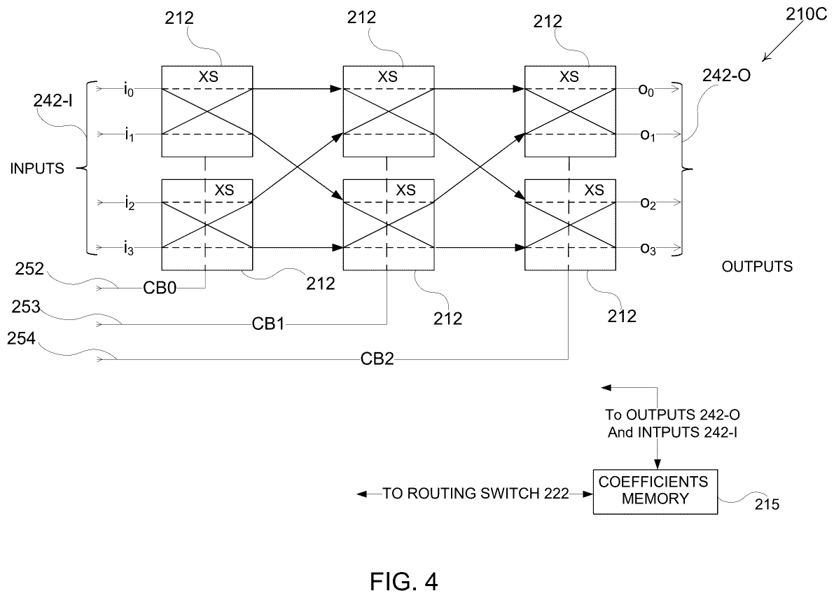

In some exemplary embodiments, routing switch (RS) 222, 224, and 226 may be implemented using permute unit 210C of FIG. 4, which will be described in detail below.

The topology of permute units 210 is designed to optimize the dataflow of coefficients between permute units 210. However, it should be noted that other topological configurations can also be implemented for a network of permute units 210. In FHE schemes with large and distributed designs, configurations such as a tree topology (like the one described above), a mesh topology, a network-on-chip (NoC), or any combination thereof may be used, as well as other suitable options.

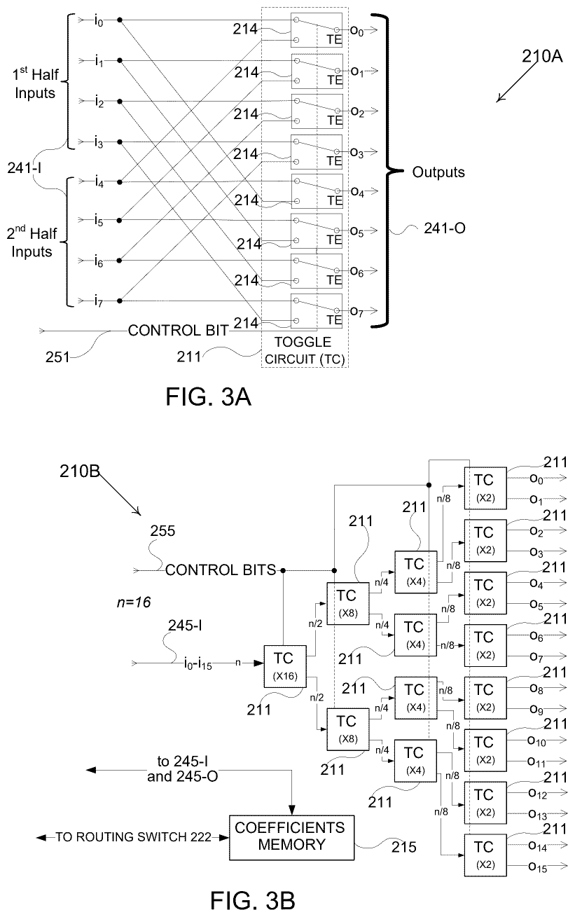

In some exemplary embodiments, each permute unit 210 includes a coefficients memory, which will be described in detail in FIGS. 3 to 6 below. In the embodiment shown in FIG. 2, there are 64 permute units 210, with each unit configured to operate on a separate set of 1024 (1K) coefficients that can be stored in its respective coefficients' memory.

It will be reminded that the disclosed embodiments are not limited to the specific architecture shown in FIGS. 1 and 2. PM 200 may be designed with a different number of permute unit 210, a different number of units in each switch level, a different arrangement of routing switches, or with a different topology and connectivity.

It should be noted that the polynomial coefficients can be arranged in any arbitrary order within permute unit 210. For example, coefficients 0-1023 may be stored in the first unit, coefficients 1024-2047 in the eighth unit, and so on. Additionally, there may be a specific ordering for the coefficients within each Permute unit 210.

In some exemplary embodiments, an optimal configuration for ordering the coefficients among the permute units 210, including the internal arrangement within each permute unit 210, may be established. This configuration can also involve adaptively configuring the network to permute coefficients across various permute units 210 to minimize dataflow traffic. In some exemplary embodiments, the optimal configuration may be determined before running an FHE program, typically during the compilation stage by a compiler (not shown). The various orderings and their optional selections are further discussed in the Ser. No. 18/809,976 Application referenced above.

In some exemplary embodiments, the permutation module (PM) 200 is defined as part of an exposed data-path architecture that enables the compiler to utilize variable resources of the permutation module and internal fabric for different permutations. The variable resources are assigned based on the permute's parameters, thereby exploiting dataflow locality derived from the optimal configuration of the order of coefficients and permutations statistics, and consequently producing shorter program runtime. That is, the instructions and the arrangement of the PM 200 allow to minimize the dataflow while maintaining an optimal performance for the FHE program. The internal fabric or an on-chip interconnect refers to the communication infrastructure used within a semiconductor chip to connect its various functional blocks, such as processors, memory, and specialized hardware accelerators. As modern chips become more complex, the efficiency of on-chip interconnects is critical to the overall performance, power consumption, and scalability of the system.

In some exemplary embodiments, management module 230 serves as an interface between PM 200 and processor 171 (as shown in FIG. 1). Module 230 defines the set of permute operations (e.g., control words) 255 to be executed by PM 200 for performing rotation and permutation operations. Management module 230 receives configuration data, i.e., instructions, from processor 171. The instructions define one or more sets of permute operations in the management module 230 and according to the relevant dataflow for each permutation, enabling the establishment of an optimal configuration for the movement of coefficients among the permute units 210. The set of control words 255 is also configured to control RS 222, 224, and 226 based on the required permutations and ordering.

In some exemplary embodiments, management module 230 may be realized as a memory containing a pre-stored look-up table that associates instructions obtained from processor 171 to control words 255 configured to control RS 222, 224, and 226 and the plurality of permute unit 210 via buffer 240 and control bus 250. It should be noted that processor 171 may alter the look-up table content as per the FHE program on hand.

FIG. 3A shows a block diagram of permute unit 210A, which is based on a toggle circuit 211, in accordance with some of the disclosed embodiments. Toggle circuit 211 may include a plurality of toggle elements 214, each having two inputs, one output, and one control bit 251 that determines which of the two inputs is passed through to the output. In the exemplary embodiment depicted in FIG. 3A, there are eight inputs 241-I (i₀ through i₇) and eight outputs 241-O (o₀ through o₇). However, it should be appreciated that the present disclosure is not limited to the exemplary embodiment shown in FIG. 3A. In some exemplary embodiments, toggle circuit 211 may be implemented with any number of inputs having an equal number of outputs to comply with a required configuration of permute unit 210A. In an embodiment, a toggle element 214 is realized as a MUX.

In some exemplary embodiments, toggle circuit 211 passes (copy) inputs 241-I to output 241-O, so that o₀-o₇, is respectively equal to i₀-i₇. Alternatively, it switches between the first half of 241-I and the second half of 241-I, so that o₀-o₃, is respectively equal to i₄-i₇, and o₄-o₇, is respectively equal to i₀-i₃. In some exemplary embodiments, control bit 251, which selects which input is passed to the output may be a segment of control-bus 250. Table 2 below shows a Truth table of the outputs according to the control bit 251 state.

TABLE 2

| | CB | C̅B̅ |
|---|---|---|
| o₀ | i₀ | i₄ |
| o₁ | i₁ | i₅ |
| o₂ | i₂ | i₆ |
| o₃ | i₃ | i₇ |
| o₄ | i₄ | i₀ |
| o₅ | i₅ | i₁ |
| o₆ | i₆ | i₂ |
| o₇ | i₇ | i₃ |

In some exemplary embodiments, permute unit 210A is utilized to perform a local permutation that supports bootstrapping with ‘bit-reverse’ polynomial coefficients. It should be noted that polynomial coefficients may be viewed in the present disclosure as operands that can undergo a permutation operation.

FIG. 3B shows a block diagram of permute unit 210B, which is based on a plurality of toggle circuit 211, in accordance with some of the disclosed embodiments.

Permute unit 210B may be arranged in stages, wherein each stage includes at least one toggle circuit 211. In the exemplary embodiment depicted in FIG. 3B, Input 245-I supports a total of 16 inputs (i₀ through i₁₅) and outputs 245-O likewise (o₀ through o₁₅), i.e., n=16. It should be noted that the embodiment depicted in FIG. 3B is arranged in four stages, wherein each stage has sixteen inputs and sixteen outputs.

It should be appreciated that the present disclosure is not limited to the exemplary embodiment shown in FIG. 3B. In some exemplary embodiments, permute unit 210B may be implemented with any number of inputs (n) having an equal number of outputs, where n=2^{x} and the number of stages is (x). Thus, permute unit 210B of the embodiment depicted in FIG. 3B has 16 inputs, 4 stages, and 16 outputs.

In some exemplary embodiments, each toggle circuit 211 either passes its inputs directly to its outputs or swaps the first half of its inputs with the second half and passes the swapped inputs to the outputs, depending on the state of its control bit of the control word 255. Additionally, the outputs of each toggle circuit 211 in permute unit 210B may be split into two parts, with each part serving as the input to a different toggle circuit 211 in the next stage.

In some exemplary embodiments, control word 255 is a segment of control bus 250, and for a number of stages k_{stages} the number of bits included in the control word 255 may be equal to 2^{k}^{_{stages}}−1 since stage i has 2ⁱ⁻¹ control bits out of control word 255 to control its toggle circuits 211. Thus, permute unit 210B of the embodiment depicted in FIG. 3B, control word 255 has 15 control bits that support a total of 32768 permutations.

It should be noted that the number of inputs, n, refers to the number of coefficients in a group. Additionally, at each stage, the number of inputs and outputs of each toggle circuit 211 is halved, while the number of toggle circuits 211 of the following stage is doubled. Therefore, the number of inputs decreases by half from one stage to the next (e.g., n, n/2, n/4, n/8).

In some exemplary embodiments, permute unit 210B further includes coefficients memory 215, which is connected via a routing switch 222 to processor 171 and internal memory 172 of FIG. 1. Coefficients memory 215 may be configured to retain a plurality of polynomial coefficients arranged in any arbitrary order. These polynomial coefficients may be referred to as operands (hereinafter, inputs) with a predefined size, on which an operation, such as a permutation, may be performed. Additionally, coefficients memory 215 may also retain the results of these operations, such as permutations (hereinafter, outputs).

In some exemplary embodiments, coefficients memory 215 may be connected to inputs 245-I, from which inputs may be obtained for operations such as permutation. Additionally, or alternatively, coefficients memory 215 may also be connected to outputs 245-O to enable the storage of the results of such operations.

In some exemplary embodiments, permute unit 210B may be utilized for permutation, required in BTS and “bit-reverse” coefficients ordering.

FIG. 4 shows a block diagram of permute unit 210C, in accordance with some of the disclosed embodiments.

Permute unit 210C may be implemented with a plurality of crossbar switches (XS) 212 that are arranged in stages, each containing at least one XS 212, with each stage controlled by a control bit.

In the exemplary embodiment depicted in FIG. 4, Input 242-I supports a total of four inputs (i₀ through i₃), with outputs 242-O corresponding to the same (o₀ through o₃). In this embodiment, permute unit 210C is arranged in three stages, each containing two XS 212. Each stage is controlled by a control bit (CB), i.e., CB0 252, CB1 253, and CB2 254, respectively, which determines which of the stage's inputs is passed through to its output.

In some exemplary embodiments, each XS 212 has two inputs, two outputs, and one control bit. XS 212 is designed to either pass its inputs directly to the outputs (dashed line) or swap the inputs (solid line).

In this embodiment, the XS 212 of Permute unit 210C is wired in a way that supports a total of five permutations.

In another embodiment, the control bits and the XS 12 are arranged in a configuration in which the control bits are separated for each switch 222. In such arrangements, 4! (factorial) permutations are supported.

It should be appreciated that the present disclosure is not limited to the exemplary embodiment shown in FIG. 4. In some exemplary embodiments, permute unit 210C can be implemented with any number of inputs, an equal number of outputs, and any number of stages. Each stage contains the same number of XS 212 units, where each XS 212 supports two inputs, which dictates the overall number of inputs.

In some exemplary embodiments, permute unit 210C may be utilized as routing switches 222, 224, and 226.

In some exemplary embodiments, permute unit 210C further includes coefficients memory 215, which is connected via a routing switch 222 to processor 171 and internal memory 172 of FIG. 1. Coefficients memory 215 may be configured to retain a plurality of polynomial coefficients arranged in any arbitrary order. These polynomial coefficients may be referred to as operands (hereinafter, inputs) with a predefined size, on which an operation, such as a permutation, may be performed. Additionally, coefficients memory 215 may also retain the results of these operations, such as permutations (hereinafter, outputs).

In some exemplary embodiments, coefficients memory 215 may be connected to inputs 242-I, from which inputs may be obtained for operations such as permutation. Additionally, or alternatively, coefficients memory 215 may also be connected to outputs 242-O to enable the storage of the results of such operations.

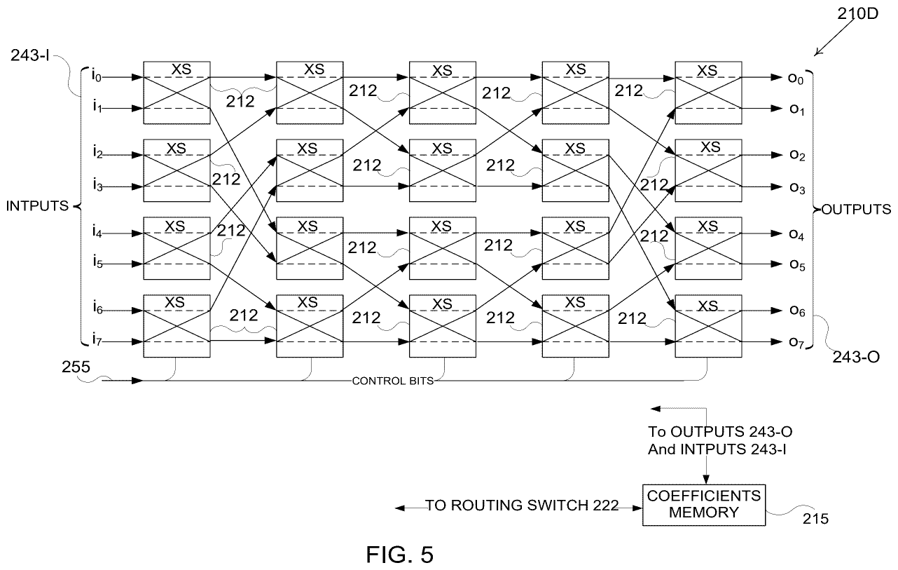

FIG. 5 shows a block diagram of permute unit 210D, in accordance with some of the disclosed embodiments.

Permute unit 210D may be implemented with a plurality of crossbar switches (XS) 212 that are arranged in stages, each containing at least one XS 212, with each switch or stage controlled by a control bit.

In the exemplary embodiment depicted in FIG. 5, Input 242-I supports a total of eight inputs (i₀ through i₇), with outputs 242-O corresponding to the same (o₀ through o₇). In this embodiment, permute unit 210D is arranged in three stages, each containing two XS 212. Each stage is controlled by one or more control bits (CBs) out of the control bus 250 which determines which of the stage's inputs is passed through to its output.

In some exemplary embodiments, each XS 212 has two inputs, two outputs, and one control bit. XS 212 is designed to either pass its inputs directly to the outputs (dashed line) or swap the inputs (solid line).

In this example embodiment, the XS 212 of Permute unit 210D is wired in a way that supports up to 32 permutations. In a typical arrangement, there would be more possible permutations with more control bits to support any given coefficient orderings.

It should be appreciated that the present disclosure is not limited to the exemplary embodiment shown in FIG. 5. In some exemplary embodiments, permute unit 210D can be implemented with any number of inputs, an equal number of outputs, and any number of stages, with the number of stages determining the number of control bits. Each stage contains the same number of XS 212 units, where each XS 212 supports two inputs, which dictates the overall number of inputs.

In some exemplary embodiments, permute unit 210D further includes coefficients memory 215, which is connected via a routing switch 222 to processor 171 and internal memory 172 of FIG. 1. Coefficients memory 215 may be configured to retain a plurality of polynomial coefficients arranged in any arbitrary order. These polynomial coefficients may be referred to as operands (hereinafter, inputs) with a predefined size, on which an operation, such as a permutation, may be performed. Additionally, coefficients memory 215 may also retain the results of these operations, such as permutations (hereinafter, outputs).

In some exemplary embodiments, coefficients memory 215 may be connected to inputs 243-I, from which inputs may be obtained for operations such as permutation. Additionally, or alternatively, coefficients memory 215 may also be connected to outputs 243-O to enable the storage of the results of such operations.

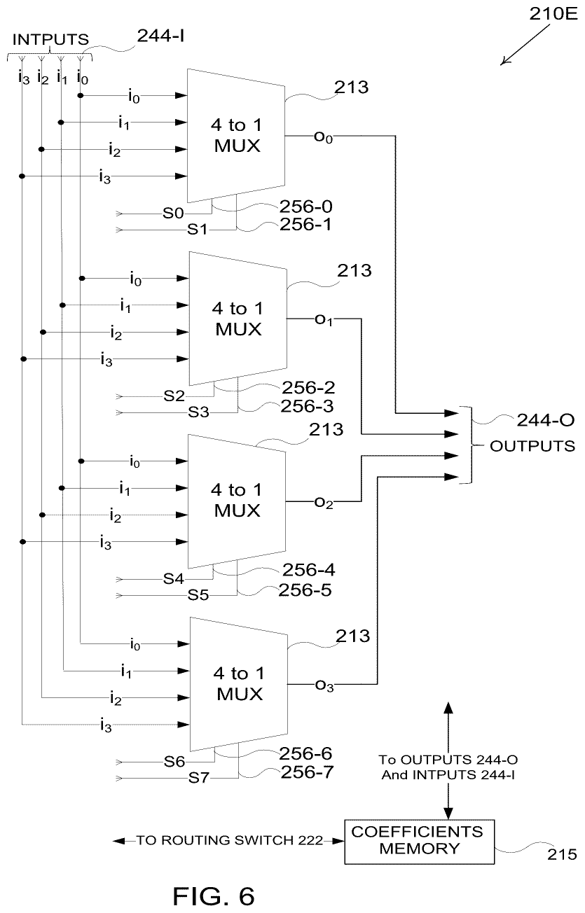

FIG. 6 shows a block diagram of permute unit 210E, in accordance with some of the disclosed embodiments.

Permute unit 210D may be implemented with a plurality of multiplexers 213 with each controlled by two different control bits. In the exemplary embodiment depicted in FIG. 6, input 244-I supports a total of four inputs (i₀ through i₃), with outputs 242-O (o₀ through o₃). In this embodiment, each multiplexer 213 may be a 4-to-1 multiplexer that selects one of the four inputs i₀ through i₃ and forwards it to a single output based on the values of its two control bits.

In this embodiment, permute unit 210E consists of four multiplexers 213, each receiving the same set of four inputs (244-I). The outputs from each of the four multiplexers combine to form the four outputs 242-O (o₀ through o₃)

In some exemplary embodiments, the first multiplexer 213 may be controlled by control bits S0 256-0 and S1 256-1, the second multiplexer 213 may be controlled by control bits S2 256-2 and S3 256-3, the third multiplexer 213 may be controlled by control bits S4 256-4 and S5 256-5, and the fourth multiplexer 213 may be controlled by control bits S6 256-6 and S7 256-7. It should be noted that S0 256-0, S1 256-1, S2 256-2, S3 256-3, S4 256-4, S5 256-5, S6 256-6, and S7 256-7 are a segment of control-bus 250.

It should be appreciated that the present disclosure is not limited to the exemplary embodiment shown in FIG. 6. In some exemplary embodiments, permute unit 210E can be implemented with any number of inputs and a corresponding number of outputs, where the number of multiplexers 213 determines the number of outputs. Additionally, multiplexer 213 is not restricted to the 4-to-1 MUX structure and can be implemented in various configurations. As a result, the number of control bits for each multiplexer 213 will vary depending on the number of inputs it receives.

In some exemplary embodiments, permute unit 210E further includes coefficients memory 215, which is connected via a routing switch 222 to processor 171 and internal memory 172 of FIG. 1. Coefficients memory 215 may be configured to retain a plurality of polynomial coefficients arranged in any arbitrary order. These polynomial coefficients may be referred to as operands (hereinafter, inputs) with a predefined size, on which an operation, such as a permutation, may be performed. Additionally, coefficients memory 215 may also retain the results of these operations, such as permutations (hereinafter, outputs).

In some exemplary embodiments, coefficients memory 215 may be connected to inputs 244-I, from which inputs may be obtained for operations such as permutation. Additionally, or alternatively, coefficients memory 215 may also be connected to outputs 244-O to enable the storage of the results of such operations.

The various embodiments disclosed herein can be implemented as hardware, firmware, software, or any combination thereof. Moreover, the software is preferably implemented as an application program tangibly embodied on a program storage unit or computer-readable medium consisting of parts or of certain devices and/or a combination of devices. The application program may be uploaded to and executed by a machine comprising any suitable architecture. Preferably, the machine is implemented on a computer platform with hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A permutation module designed to be utilized by a fully homomorphic encryption (FHE) accelerator, comprising:
a plurality of permute units, wherein each of the plurality of permute units is configured to perform local permutations on polynomial coefficients of an FHE program executed by the FHE accelerator;
wherein the plurality of permute units are controlled by a set of permute operations, and
wherein the permute operations are derived from instructions complied to minimize dataflows of coefficients in the FHE accelerator while utilizing variable resources of the permutation module and an internal fabric for different permutations.

2. The permutation module of claim 1, further comprising:
a control bus configured to provide connectivity between the plurality of permute units via the plurality of routing switches; and
a plurality of routing switches connected to one another and to at least one permute unit, the plurality of routing switches are configured to allow dataflows among the plurality of permute units.

3. The permutation module of claim 2, further comprising:
a management module configured to control the plurality of permute units and the plurality of routing switches via the control bus, wherein the management module is configured to receive the instructions from a processor of the FHE accelerator and provide the permute operations.

4. The permutation module of claim 1, wherein the variable resources are assigned based on permute parameters, derived from an optimal configuration of coefficients ordering and permutation statistics.

5. The permutation module of claim 1, wherein the plurality of permute units are arranged in a preconfigured topology.

6. The permutation module of claim 5, wherein the internal fabric is arranged as a network-on-chip (NoC), wherein a NoC arrangement is any one of: a tree topology, a mesh topology.

7. The permutation module of claim 1, wherein each of the plurality permute units permutes a set of polynomial coefficients, wherein a set of polynomial coefficients are arranged in any arbitrary order within a permute unit.

8. The permutation module of claim 1, wherein each of the plurality permute units includes a plurality of crossbar switches arranged in stages, wherein each stage contains at least one crossbar switch, wherein the plurality of crossbar switches are controlled by the instructions.

9. The permutation module of claim 1, wherein each of the plurality permute units includes a plurality of toggle circuits, each of which having a plurality of toggle elements, wherein each of the plurality of toggle elements includes at least two inputs and one output and is controlled by the instructions.

10. The permutation module of claim 1, wherein each of the plurality of permute units includes a plurality of multiplexers controlled by the instructions.

11. The permutation module of claim 1, wherein received instructions are determined by an ordering scheme selected based in part on a topology of the permutation module and parameters of the FHE program.

12. The permutation module of claim 11, wherein the ordering scheme is anyone: a regular ordering, a bit-reverse ordering, an even-odd ordering, and a naïve ordering.

13. The permutation module of claim 1, wherein the internal fabric is of a semiconductor chip on which the permutation module is fabricated.
